(19) United States
(12) Patent Application Publication
(10) Pub. No.: US 2004/0237318 A1
(43) Pub. Date: Dec. 2, 2004

(54) Outer cutter for an electric shaver and an electric shaver using the same

(75) Inventor: Hiromi Uchiyama, Matsumoto (JP)

Correspondence Address: KODA & ANDROLIA, 2029 CENTURY PARK EAST, SUITE 1430, LOS ANGELES, CA, 90067-3024, US

(73) Assignee: IZUMI PRODUCTS COMPANY

(21) Appl. No.: 10/857,196

(22) Filed: May 28, 2004

(30) Foreign Application Priority Data
May 28, 2003 (JP) 2003-150619

(51) Int. Cl. B26B 19/04

(52) U.S. Cl. 30/346.51

(57) ABSTRACT

An outer cutter formed with hair introduction slits and attached to an electric shaver in a substantially inverted U-shape, in which recessed portions, in which the shaving surface side of the outer cutter is recessed, are provided adjacent to one or both end portions of the slits, so that the end portions of the slits are formed as hair introduction openings that introduce hair.

### BACKGROUND OF THE INVENTION

1. Field of the Invention

The present invention relates to an outer cutter formed with slits and attached to an electric shaver in a substantially inverted U-shape and to electric shaver that uses such an outer cutter.

2. Prior Art

FIG. 7 is a top view of a conventional reciprocating type outer cutter for an electric shaver.

In this outer cutter 100 for an electric shaver shown in FIG. 7, numerous round holes 108 are formed in the central portion of a thin, substantially rectangular metal plate, and numerous slits 104 are formed in both ends of this metal plate.

In this outer cutter 100, hair introduction holes with different shapes (as described above) are arranged in rows with the aim of combining the characteristics of the respective hair introduction holes in order to introduce hair in an efficient manner. In other words, round holes 108 are installed for use in deep shaving that further shortens hair having a length that allows easy entry into the round holes 108, while the slits 104 are installed for use in rough shaving in which hair that has grown long and is thus difficult to enter into the round holes 108 is introduced therein along the direction of length of the slits 104 and cut.

Since the round holes 108 are installed for use in deep shaving, it is desirable that these round holes 108 be formed in a metal plate that is small in thickness. For the slits 104, on the other hand, unless they are formed in a metal plate that has a certain thickness, there is a danger that the skin enters the slits 104 and is injured by the inner cutter (so-called shaver burn).

Accordingly, the regions in which the slits 104 are formed are set at a specified thickness (thick regions 102) that can prevent shaver burn, and the region in which the round holes 108 are formed are set at a smaller thickness (thin region 106) than the thick regions 102.

An outer cutter that has a thick region and a thin region is disclosed in, for instance, U.S. Pat. No. 3,564,715.

However, the outer cutter 100 described above has problems. In cases where long hair is shaved, it is difficult to introduce such long hair into the slits 104 formed in the thick regions 102, which are formed with a uniform thickness. In other words, when, as shown in FIG. 8, the shaving surface 110 of the outer cutter 100 is moved while being pressed against the skin in the direction of arrow, hair 112 that is parallel to the direction of length of the slits 104 is easily introduced into the slits 104; however, hair 114 that is inclined in a direction that crosses the direction of length of the slits 104 at an angle is not easily introduced into the slits 104 and remain without being shaved.

### SUMMARY OF THE INVENTION

Accordingly, the present invention is to solve the problems in the above-described prior art.

The object of the present invention is to provide an outer cutter for an electric shaver and an electric shaver that efficiently introduces hair into the slits.

The above object is accomplished by a unique structure of the present invention for an outer cutter for an electric shaver, in which the outer cutter is in the form of a metal plate provided with hair introduction slits and bent, when installed in the shaver, in a substantially inverted U-shape; and in the present invention, a recessed portion in which a shaving surface side of said outer cutter is recessed is disposed adjacent to one end or both ends of at least one of the slits, so that the recessed portion(s) at the end(s) of the slit(s) makes a hair introduction opening that introduces hair into the slit.

In this structure, the recessed portion(s) is disposed along the outlines of the end portions of the slit(s). The outer cutter can be formed, in addition to the slits, with other hair introduction openings than the slits.

The above object is accomplished by another unique structure of the present invention for an outer cutter for an electric shaver, in which the outer cutter is in the form of a thin plate and bent, when installed in the shaver, in a substantially inverted U-shape; and in the present invention, the outer cutter is provide with:

a thick region which has a large thickness and in which hair introduction slits are formed, and

a thin region which is formed with a smaller thickness than the thick region and in which hair introduction holes are formed; and wherein

at least one end of at least one of the slits is adjacent to the thin region, so that the one end of the slit is formed as hair introduction opening that introduces hair into the slit.

In the present invention, a boundary between the thick region and the thin region is formed straight, and at least one end of at least one slit is positioned on the boundary and provided adjacent to the thin region, thus being opened toward the thin region.

In this structure, the above-described “boundary is formed straight” means that the boundary is formed with a rectilinear shape in the flat-plate-form state of the outer cutter before it is attached to the electric shaver. Furthermore, this indication that “the boundary is straight” does not mean that the boundary is formed with a completely rectilinear shape from one end to the other, and it is sufficient that the boundary be substantially rectilinear. For instance, one end of the boundary can be curved.

The boundary between the thick region and the thin region can be formed in a wave shape. In this case as well, the boundary can be in a wave shape partially and not for its entire length.

In addition, the slits are formed so that the lengthwise direction of the slits is in perpendicular to the boundary. With this arrangement, hair that is introduced through the hair introduction openings is readily introduced into the slits along the inner side wall surfaces of the slits.

In the above structure, a substantially central portion of the thin region form a top ridge of the outer cutter when the outer cutter is mounted on the shaver in a substantially inverted U-shape.

In addition, the boundary between the thick region and the thin region is substantially parallel to the top ridge of the installed outer cutter. The boundary is not necessarily rectilinear, and it can take a wave shape. Thus, the boundary can be roughly parallel to the top ridge of the outer cutter installed and in an inverted U-shape.

Preferably, the slit is 2 mm or greater in length and 0.3 mm or less in width.

The present invention further provides an electric shaver that is provided with an outer cutter described above and an inner cutter that makes sliding contact with the inside surface of the outer cutter.

### BRIEF DESCRIPTION OF THE DRAWINGS

FIG. 1A is a top view of the outer cutter for an electric shaver of one embodiment according to the present invention, and FIG. 1B is a sectional view taken along the line 1B-1B of FIG. 1A;

FIG. 2 illustrates the overall construction of the electric shaver of the present invention;

FIG. 3 is an enlarged partial perspective view of the outer cutter of the present invention attached to the cutter head of the electric shaver;

FIGS. 4A through 4C are explanatory diagrams showing a hair cutting process by the outer cutter of the present invention;

FIG. 5 is an enlarged view showing the area near the end portion of one of the slits formed in the outer cutter of the present invention, the oblique lines not indicative of the cross-sectional surfaces of the parts;

FIG. 6A is a partial top view of another embodiment of the outer cutter for an electric shaver of the present invention, and FIG. 6B is a sectional view taken along the line 6B-6B of FIG. 6A, the oblique lines in FIG. 6A not indicative of the cross-sectional surfaces of the parts;

FIG. 7 is a top view of a conventional outer cutter for an electric shaver, and FIG. 7B is a sectional view taken along the lines 7B-7B of FIG. 7A; and

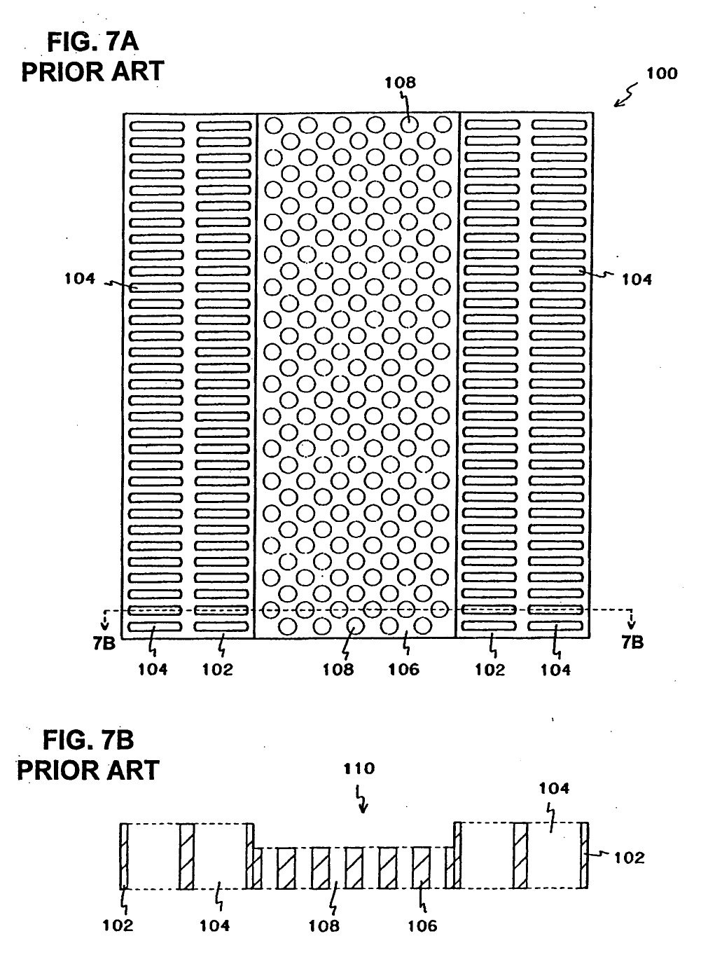

FIG. 8 is an enlarged partial perspective view of the outer cutter of FIG. 7, showing the manner of cutting the hair.

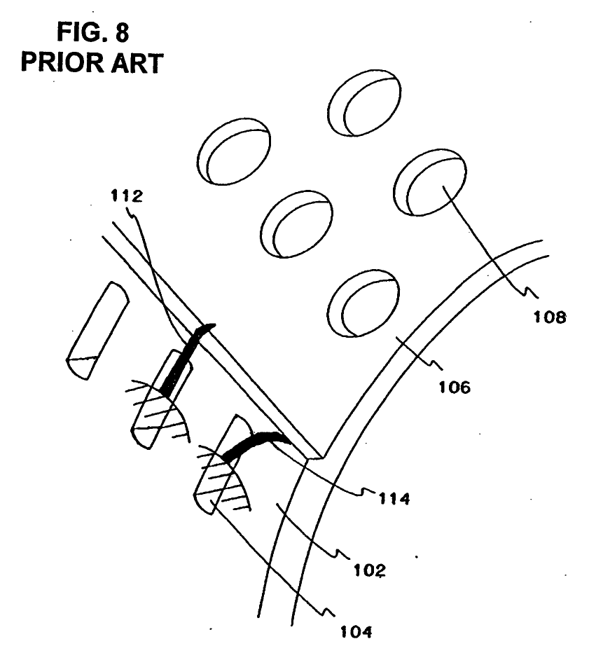

### DETAILED DESCRIPTION OF THE INVENTION

Preferred embodiments of the electric shaver of the present invention will be described in detail below with reference to the accompanying drawings.

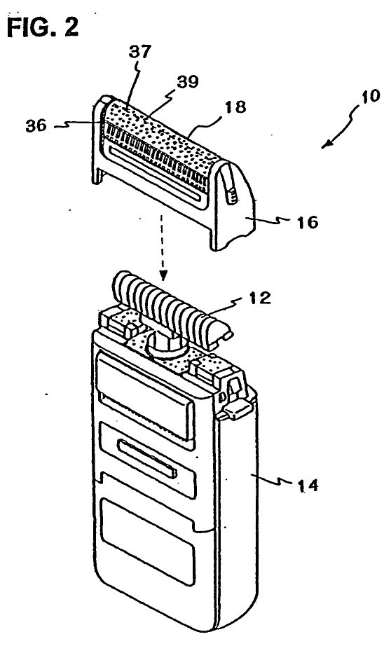

As seen from FIG. 2, the electric shaver 10 of the shown embodiment is a reciprocating type electric shaver, and it comprises a main body housing 14 and a cutter head 16. The main body housing 14 has an inner cutter 12 attached to the upper end and contains driving parts that cause this inner cutter 12 to make a reciprocating motion. The cutter head 16 is detachably mounted on the upper portion of the main body housing 14, and an outer cutter 18 that makes sliding contact with the inner cutter 12 is attached to the cutter head 16.

The outer cutter 18 of this cutter head 16 comprises a thin metal plate which is in a substantially rectangular shape and in which numerous or a plurality of hair introduction holes (detailed below) are formed. The outer cutter 18 is bent along the shorter-side 18a so that the outer cutter 18 is mounted on and attached to the cutter head 16 in a substantially inverted U-shape.

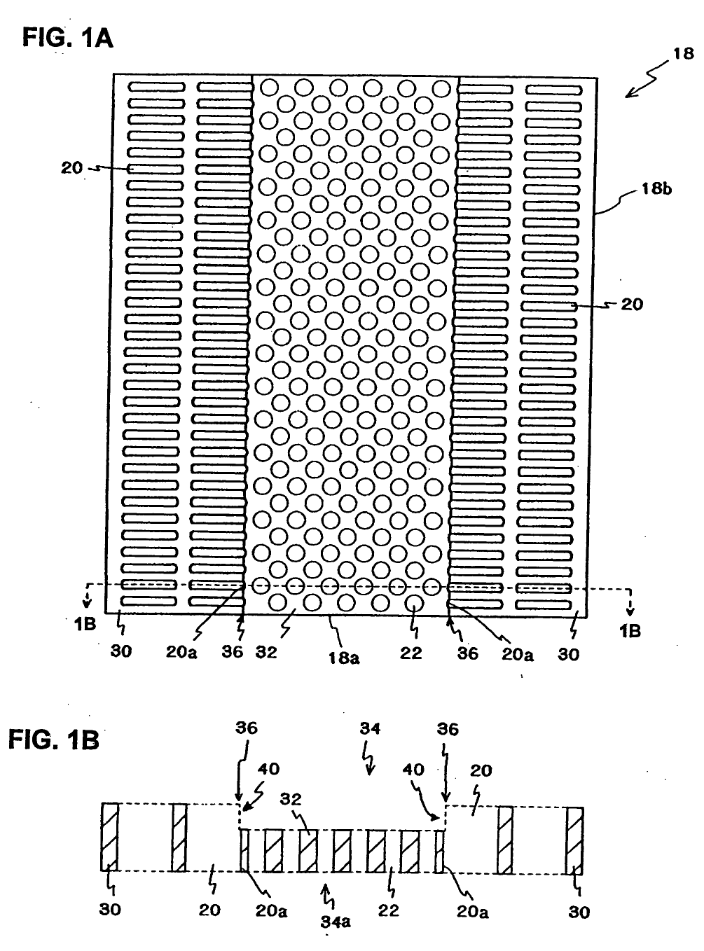

As seen from FIGS. 1A and 1B, the outer cutter 18 is comprised of thick regions 30 and a thin region 32. Each of the thick regions 30 is formed with a large thickness, and numerous slits 20 are formed as hair introduction holes used for rough shaving. The thin region 32, which is between the thick regions 30, is formed with a smaller thickness than the thick region 30, and numerous round holes 22 are formed as hair introduction holes used for deep shaving.

In this outer cutter 18 that includes the thick and thin regions 30 and 32, its shaving (or outer) surface 34 is formed uneven due to the differences in the thickness of the metal plate (or due to the thick and thin regions 30 and 32), and the inside surface 34a with which the inner cutter 12 makes sliding contact is formed flat.

In the shown outer cutter 18, the thick regions 30 and thin region 32 are respectively formed in a band shape that extends in the direction of length (or extends parallel to the longer-side 18b) of the outer cutter 18. The thick regions 30 are on both sides of the shorter-side 18a of the outer cutter 18, and the thin region 32 is in the middle of or in the center of the two thick regions 30.

As a result of this construction of the outer cutter 18, when the outer cutter 18 is attached to the cutter head 16 in a substantially inverted U-shape as shown in FIG. 2, the top part or the top ridge 37 of the curved outer cutter 18 is formed by the center of the thin region 32. As a result, deep shaving is performed by the top part 37 or by the top ridge area of the outer cutter which most frequently comes into contact with the skin; and for such an area as beneath the jaw, etc. that is generally difficult to shave with an electric shaver and shaving stubble tends to generate, the thick regions 30 of the outer cutter 18 are brought to make contact with such an area, thus cutting long hair that has been left in shaving by tilting the shaver.

Furthermore, since the thin region 32 which has a small thickness and is therefore flexible is positioned on the curved top part 37, and the thick regions 30 which have a larger thickness and are therefore rigid are positioned on both sides of the top part 37 or the top ridge, it is easy to mount the outer cutter 18 on the cutter head 16 of the electric shaver 10.

Here, the outer cutter of the present invention is characterized by the fact that this outer cutter is formed so as to easily introduce hair into the slits. More specifically, the slits (hair introduction slits) are formed so that the end portions of the slits are adjacent to recessed portions in which the shaving surface side of the outer cutter is recessed, so that the end portions of the slits are opened so as to be hair introduction openings, thus introducing the hair into the slits via the hair introduction openings.

More specifically, in the shown embodiment, the hair introduction slits (called “slit(s)”) 20 in the thick regions 30 are formed so that at least one end (inner side) portion 20a of at least one slit 20 is adjacent to the thin region 32 which is a recessed portion that is recessed and made thinner (or has a smaller thickness) than the thick regions 30. The construction of the outer cutter 18 of the shown embodiment will be described in detail below.

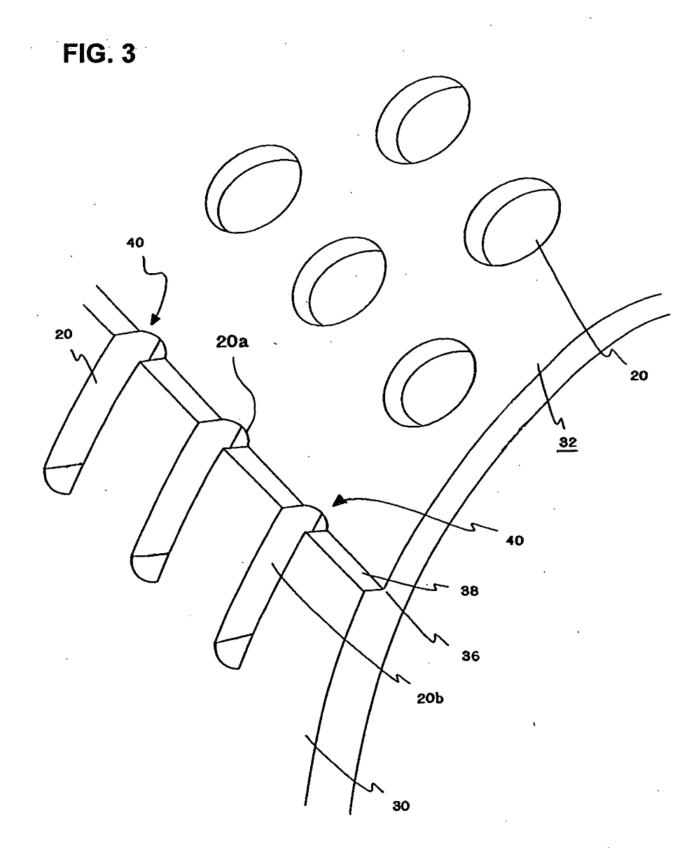

In the outer cutter 18 of the shown embodiment, as seen from FIG. 1, each of the boundaries 36 between the thick regions 30 and the thin region 32 is formed as a rectilinear boundary, and the shaving surface 34 (which is the outer surface when the outer cutter 18 is installed in the shaver) at the boundaries 36 is formed into step portions 38 (see FIG. 3) by differences in the thickness of the thick and thin regions 30 and 32. Furthermore, two rows of slits 20 are formed in each of the thick regions 30, and the slits 20 that are disposed along the boundaries 36 (among the slits formed in the thick regions 30) are formed so that one end portion 20a of each one of the slits 20 is on the boundary 36 so that the end portions 20a of the slits 20 are adjacent to the thin region 32.

As shown in FIG. 3, since the end portions 20a of the slits 20 are adjacent to the thin region 32, the end portions 20a of these slits 20 are positioned on the boundary(s) 36 and thus the end portions 20a are opened in the step portion 38. As a result, the slits 20 have the depth that is equal to the thickness of the thick region 30, and they have the end portions 20a opened in the step portion 38. Accordingly, the open end portions 20a of the slits 20 act as hair introduction openings into which hair is introduced. More specifically, the hair introduction openings 40 are formed with a shape that runs between the thin region 32 and the inner side wall surfaces 20b of each of the slits 20. Accordingly, hair that slides, during shaving, toward the thick regions 30 while contacting the shaving surface of the thin region 32 enters the slits 20 via the hair introduction openings 40 without being caused to ride over the step portion(s) 38. As a result, hair can be efficiently introduced into the slits 20 from the end portions 20a of the slits 20.

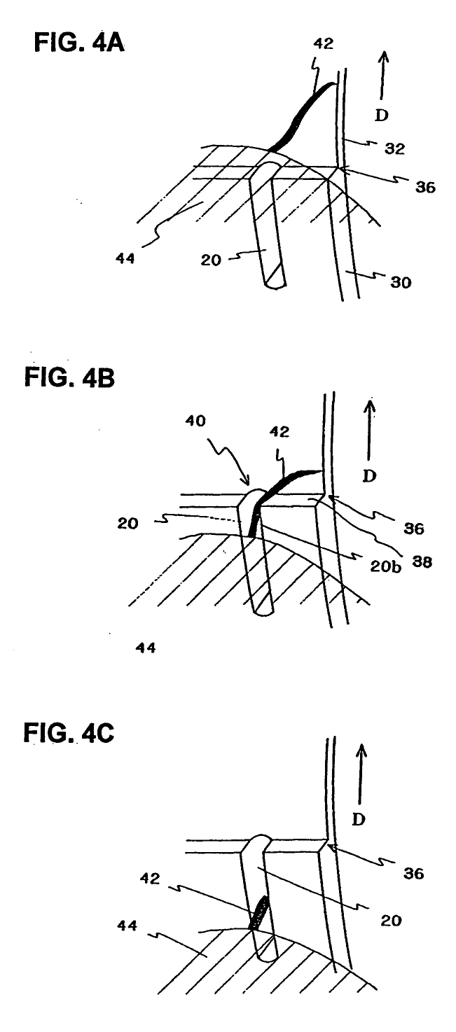

The slits 20 are provided so that the direction of the length of the slits is perpendicular to the boundaries 36 that are between the two thick regions 30 and the single thin region 32, and the step portions 38 of the boundaries 36 and the inner side wall surfaces 20b of the slits 20 are perpendicular to each other. As a result of these configurations, as will be clear from the description below with reference to FIGS. 4A through 4C, when the root portion of hair that is inclined in a direction that crosses the direction of length of the slits 20 enters the hair introduction openings 40, hair is guided by the step portions 38 and inner side wall surfaces 20b, the direction of inclination of the hair is altered to the direction of length of the slits 20, and hair is thus introduced into the slits 20. As a result, even the hair that crosses the direction of length of the slits 20 can be appropriately introduced into the slits 20.

In the above outer cutter 18, the slits 20 are formed at a specified spacing along the rectilinear boundaries 36 or along the longer-side 18b of the outer cutter. As a result, the boundaries 36 are in the shape of comb form blades in which the step portions 38 and the hair introduction openings 40 are alternately disposed. Accordingly, hair that has grown long can be efficiently introduced into the slits 20 by numerous hair introduction openings 40. Even in cases where hair is not introduced into the slits 20, the direction of inclination of the hair can be uniformly arranged by the slits 20 that have the shape of a comb form blade, so that hair can easily be introduced by way of moving the shaver back and forth several times.

As seen from FIG. 2, the boundaries 36 of the outer cutter 18 are rectilinear and substantially parallel to a top ridge (or ridge line) 39 (a line connecting the top points of the outer cutter 18 attached in a substantially inverted U-shape) when the outer cutter 18 is attached to the cutter head 16. Ordinarily, when the electric shaver is used, the top part 37 of the outer cutter 18 first comes into contact with the skin, and then the shaver is moved in the direction of the length of the slits so that the inclined surface (or side surface) of the U-shaped outer cutter 18 contacts the skin. Accordingly, since the hair introduction openings 40 of the slits 20 open to face the direction of movement of the shaver, hair is efficiently introduced into the slits 20 from the hair introduction openings 40.

Next, the operation of the electric shaver 10 of the shown embodiment will be described.

FIGS. 4A through 4C show how the hair is introduced into the slits 20 formed in the outer cutter 18 of the electric shaver 10 of the shown embodiment, and how the hair is cut. In FIGS. 4a through 4C, the shaving surface 34 of the outer cutter 18 is brought to contact the skin 44 and moved in the direction of arrow D that causes one of the boundaries 36 to approach the hair 42 from the thin region 32.

As shown in FIG. 4A, when the electric shaver 10 is moved in the direction of arrow D, one of the boundaries 36 of the outer cutter 18 approaches the hair 42 that is inclined in a direction that crosses the direction of length of the slits 20 and in contact with the shaving surface 34 of the thin region 32 of the outer cutter 18.

Then, as shown in FIG. 4B, when the shaver 10 is further moved in the direction of arrow D, the root portion of the hair 42 enters the hair introduction openings 40 of the step portions 38 that are formed by the end portions of the slits opened in the step portion 38, and the hair 42 is guided by the step portion 38 at the boundary 36 and the inner side wall surfaces 20b of the slits 20, so that the hair 42 is introduced into the slits 20 while the direction of inclination of the hair 42 is altered to the direction of length of the slits 20.

Then, when the shaver 10 is further moved in the direction of arrow D in FIG. 4C, the introduced hair 42 enters the slits 20 as far as the tip end portion thereof, and the hair 42 stands upright in a direction perpendicular to the shaving surface and are cut by an inner cutter (not shown) that makes sliding contact with the inside surface of the outer cutter 18.

In the above embodiment, the boundaries 36 are straight and perpendicular to the direction of length of the slits 20. However, the present invention is not limited to such an arrangement. It is also possible to form the boundaries 36 with a wave shape or the like. In this case as well, inclined hair can be guided and introduced into the slits by the step portions disposed at the wave-form boundaries and the inner side wall surfaces of the slits.

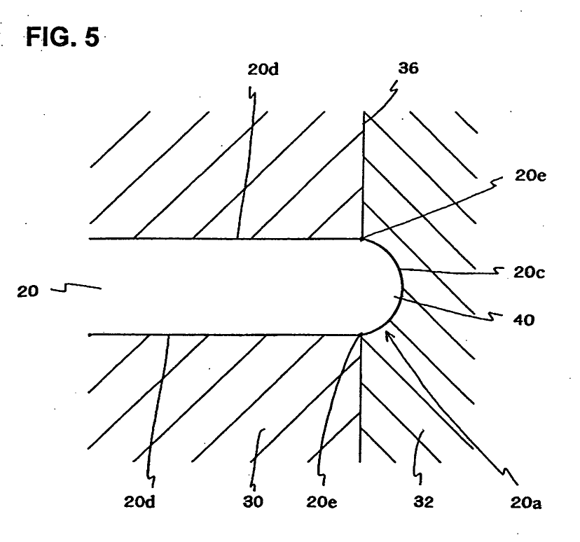

FIG. 5 shows the detail of the area in the vicinity of the end portion 20a of one of the slits 20.

As seen from FIG. 5, each slit 20 is formed from parallel long sides 20d (from which the inner side wall surfaces 20b extend) and a radius curve portion 20c curved in such a direction that this curve portion protrudes outward (or toward the thin region 32) from the end portions 20e of the long sides 20d. Thus, the slit 20 with a depth equal to the thickness of the thick region 30 has a semi circular end portion 20c that is formed continuously to the slit 20 and has a depth equal to the thickness of the thin region 32.

The “end portion 20a of the slit 20” refers to the portion that extends from the area of the long sides 20d in the vicinity of the radius curve portion 20c to the area where the boundary 36 crosses the radius curve portion 20c at two points and thus an hair introduction opening is formed in the slit 20.

In the shown embodiment, the slits 20 are formed so that the boundary 36 passes through the end portions 20e of the long sides 20d of the slits 20, and the hair introduction openings 40 are opened with the same width as the width dimension of the slits 20 and are disposed so that hair can be efficiently introduced into the slits 20.

The slits 20 that are formed in the thick regions 30 introduce long hair that cannot be shaved by the round hair introduction holes 22. Accordingly, it is preferable that these slits 20 be formed with a length of 20 mm or longer; and in order to prevent shaver bum, it is preferable that the slits 20 be formed with a width of 0.3 mm or less.

Other configurations of the outer cutter for an electric shaver of the present invention will be described below.

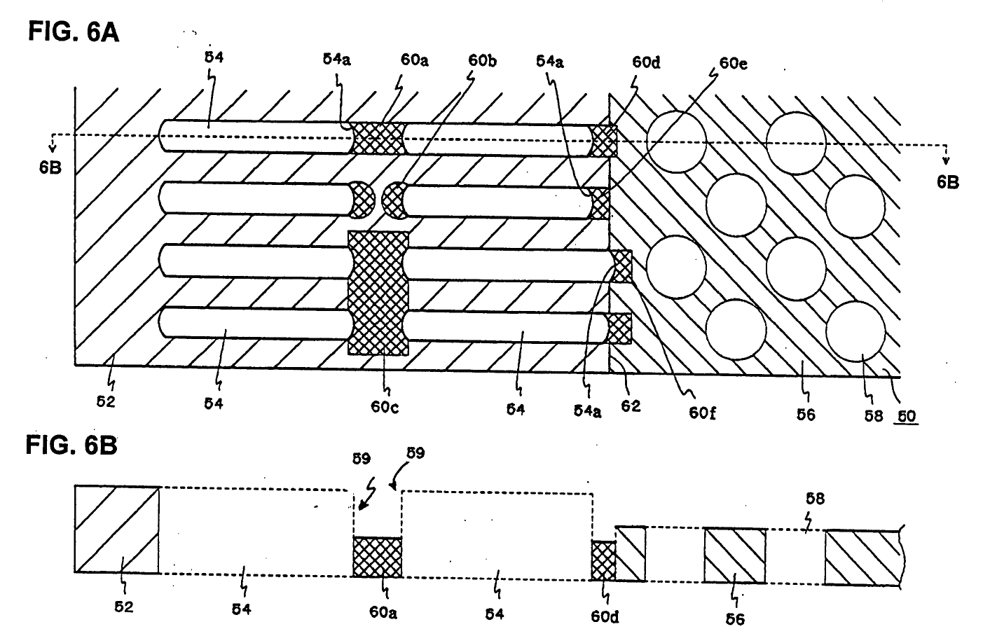

In the outer cutter 50 shown in FIGS. 6A and 6B, the end portions 20a of the slits 20 are not caused to open by differences in thickness between the thick regions 30 and the thin region 32 as in the outer cutter 18 shown in FIG. 1; instead, recessed portions in which the shaving surface side of the outer cutter is recessed are formed adjacent to the end portions 54a of slits 54 formed in thick regions 52, so that the end portions 54a of the slits 54 are opened.

The recessed portions formed in the outer cutter 50 of FIGS. 6A and 6B may be in various shapes as referred to by the reference numerals 60a, 60b, 60c and 60d.

The outer cutter 50 shown in FIG. 6A comprises thick regions 52 (only one thick region shown), in which slits 54 are formed, and a thin region 56, in which round holes 58 are formed. In the thick regions 52 of this outer cutter 50, recessed portions in which the shaving surface side of the outer cutter is recessed are formed adjacent to the end portions 54a of the slits 54 formed in the thick regions 52. The end portions 54a of the slits 54 are opened by the recessed portions 60, so that the end portions 54a are formed into and act as hair introduction openings 59 that introduce hair.

The recessed portion 60a is formed with a recessed shape between two slits 54 in which the end portions 54a of the two slits 54 face each other and is formed with the same width dimension as the slits 54, so that the facing end portions 54a are continuous. As a result, hair introduction openings 59 are formed in the end portions 54a of the slits 54, so that hair can be introduced via these hair introduction openings 59. In other words, the area (60a) between two slits 54 which are formed next to each other in the slit's lengthwise direction in the thick region 52 is formed so that such area on the shaving surface side of the outer cutter is recessed or dented so as to have a thickness that is smaller than the thickness of the thick region 52.

The recessed portions 60b are formed in a circular arc shape, which covers the end portion 54a, in the end portions 54a of each of the slits 54.

The recessed portion 60c is formed in the form of a groove between slits 54 in which the end portions 54a of these slits 54 face each other, so that the recessed portion extends in the direction perpendicular to the direction of length of the slits 54 so that the recessed portion is adjacent to the end portions 54a of a plurality of slits 54.

It is also possible to form recessed portions 60d so that these recessed portions straddle the boundary 62 between the thick region 52 and thin region 56, and it is further possible to form recessed portions 60e that extend to the boundary 62 from the end portions 54a of the slits 54 formed in the thick region 52.

In addition, within the thin region 56, recessed portions 60f can be formed thinner than the thickness of the thin region 56 so as to be disposed adjacent to the end portions 54a of the slits 54. In this structure, as a result of the recessed portions 60f being formed with a smaller thickness than the thin region 56, the hair introduction openings of the slits 54 open more widely than the hair introduction openings 40 shown in FIG. 1, so that the advantage of easy introduction of hair is obtained.

In FIG. 6A, the recessed portions 60 are formed adjacent to only one end portion 54a of each slit 54. However, it is also possible to form recessed portions 60 adjacent to both end portions 54a of each slit 54.

The present invention is not limited to an outer cutter in which slits and round holes are formed, and it is possible to form recessed portions adjacent to the end portions of the slits in an outer cutter in which slits are formed in a metal plate that has a uniform thickness.

Furthermore, the outer cutter of the present invention is not limited to the structures described above, and modifications can be made within the spirit of the present invention.

For example, in the above embodiments, the slits are formed in a direction that is perpendicular to the boundaries. However, the slits can be obliquely oriented with respect to the boundaries. Furthermore, in the above embodiments, the outer cutter is sectioned into three equal parts in the direction of the shorter-side 18a, and thick and thin regions are alternately formed. However, the outer cutter can be sectioned in strip form into two parts or into four or more parts. In addition, the thick and thin regions formed by the sections are disposed in a direction parallel to the driving direction of the inner cutter or parallel to the longer-side 18b of the outer cutter; however, it is also possible to sections the outer cutter into regions in a direction perpendicular to the driving direction of the inner cutter 12.

In the shown embodiments, the shaver is a single row type electric shaver in which only a single outer cutter is provided as shown in FIG. 2. However, the present invention is not limited to such an electric shaver; and the electric shaver of the present invention can be a multi-row type electric shaver in which a plurality of outer cutters are provided side by side.

In one of conventional electric shavers, an outer cutter that is used for rough shaving and is provided only slits is separately installed among other outer cutters provided in multiple rows. The outer cutter of the present invention efficiently introduces and cuts long hair by the slits, hair can be appropriately shaved even if an outer cutter for rough shaving is not separately installed.

In the embodiments described above, round hair introduction holes (22, 58) are formed in the thin region. However, such holes can be polygonal, oval or the like in shape or can be in a slit form.

Furthermore, in the above embodiments, the thickness of the metal plate that forms the outer cutter is segmented into two, i.e., the thick region and the thin region. However, it is also possible that the outer cutter have, for instance, three different thicknesses with a region that is in even smaller thickness than the thin region.

In addition, the above description is made on a reciprocating type electric shaver in which the reciprocating inner cutter makes sliding contact with an outer cutter attached in a substantially inverted U-shape. However, the present invention is not limited to this, and the electric shaver of the present invention can be a rotary type electric shaver in which a rotating inner cutter of a spiral form makes sliding contact with the inside surface of an outer cutter having a substantially inverted U-shape.

As seen from the above, according to the outer cutter of the present invention and to an electric shaver that has the outer cutter of the present invention, recessed portions, in which the shaving surface side of the outer cutter is recessed, are formed adjacent to each other in the end portions of the slits. Therefore, the end portions of the slits work as hair introduction openings, so that hair can be efficiently introduced into the slits.

1. An outer cutter for an electric shaver, said outer cutter being in a plate form and bent, when installed in said shaver, in a substantially inverted U-shape, said outer cutter comprising:
a thick region in which a plurality of hair introduction slits are formed, and
a thin region which is formed with a smaller thickness than said thick region and in which hair introduction holes are formed; and wherein
at least one end of at least one of said plurality of hair introduction slits is provided adjacent to said thin region, and at least one end of said at least one of said plurality of hair introduction slit is formed as a hair introduction opening that introduces hair.

2. The outer cutter for an electric shaver according to claim 1, wherein a boundary between said thick region and said thin region is in a rectilinear shape, and said at least one end of said at least one of said hair introduction slits is positioned on said boundary and provided adjacent to said thin region.

3. The outer cutter for an electric shaver according to claim 1, wherein said boundary between said thick region and said thin region is formed in a wave shape.

4. The outer cutter for an electric shaver according to claim 3, said plurality of hair introduction slits are formed so that a direction of length of said hair introduction slits is perpendicular to said boundary.

5. The outer cutter for an electric shaver according to any one of claims 1 through 4, wherein a substantially central portion of said thin region forms a top ridge of said outer cutter attached to said electric shaver in said substantially inverted U-shape.

6. The outer cutter for an electric shaver according to claim 5, wherein said boundary between said thick region and said thin region is substantially parallel to said top ridge of said outer cutter.

7. An outer cutter for an electric shaver, said outer cutter being in a plate form with hair introduction slits and bent, when installed in said shaver, in a substantially inverted U-shape, wherein
a recessed portion in which a shaving surface side of said outer cutter is recessed is disposed adjacent to at least one end of at least one of said hair introduction slits,
so that said recessed portion at at least one end of said at least one of said slits is formed as hair introduction opening that introduces hair.

8. The outer cutter for an electric shaver according to claim 1 or 7, wherein said slit has a length of 2 mm or greater and a width of 0.3 mm or less.

9. An electric shaver comprising said outer cutter according to any one of claims 1 through 7 and an inner cutter that makes sliding contact with an inside surface of said outer cutter.

10. An outer cutter for an electric shaver, said outer cutter being in a plate form and bent, when installed in said shaver, in a substantially inverted U-shape, said outer cutter comprising:
a thick region provided with a plurality of hair introduction slits,
a thin region which has a thickness less than a thickness of said thick region and is provided with a plurality of hair introduction holes, and
a step portion formed by a difference in thickness of said thick region and said thin region so as to be along a boundary between said thick region and said thin region; wherein
one end of at least one of said plurality of hair introduction slits is opened in said step portion, thus being a hair introduction opening.
